(19) United States
(12) Patent Application Publication
(10) Pub. No.: US 2026/0098746 A1
(43) Pub. Date: Apr. 9, 2026

(54) SYSTEMS AND METHODS FOR DETECTING QUARTER WINDOW BREAKAGE IN A VEHICLE

(71) Applicant: GM GLOBAL TECHNOLOGY OPERATIONS LLC, Detroit, MI (US)

(72) Inventors: Yu Feng, Rochester Hills, MI (US); Cesar Augusto Tesser Gimenes, Sterling Heights, MI (US)

(73) Assignee: GM GLOBAL TECHNOLOGY OPERATIONS LLC, Detroit, MI (US)

(21) Appl. No.: 18/905,297

(22) Filed: Oct. 3, 2024

(51) Int. Cl. G01D 5/20; B60J 1/10; B60J 1/20; B60R 16/03

(52) U.S. Cl. CPC G01D 5/20; B60J 1/10; B60J 1/20; B60R 16/03

(57) ABSTRACT

Systems and methods for detecting quarter window breakage in a vehicle are provided. A print is disposed on a surface of a quarter window. A proximity sensor is disposed inside the vehicle within a pre-defined distance of the print on the surface of the quarter window. The proximity sensor is configured to generate a first signal in response to detection of the print within a sensor detection range and generate a second signal responsive to a lack of detection of the print with the sensor detection range. A controller is communicatively coupled to the proximity sensor and configured to issue a quarter window breakage notification for transmission to a vehicle alarm system in response to receiving the second signal from the proximity sensor.

### INTRODUCTION

The technical field generally relates to vehicles, and more particularly relates to systems and methods for detecting quarter window breakage in a vehicle.

Many vehicles include one or more quarter windows. Quarter windows are often disposed behind the second row of seats in the vehicles. Intrusion sensors in the vehicles are typically unable to detect window breakages, such as for example quarter window breakages, which occur behind the second row of seats in the vehicle.

Accordingly, it is desirable to provide systems and methods for detecting quarter window breakage in a vehicle. Other desirable features and characteristics will become apparent from the subsequent detailed description and the appended claims, taken in conjunction with the accompanying drawings and the foregoing technical field and background.

### SUMMARY

A system for detecting quarter window breakage in a vehicle includes a print disposed on a surface of a quarter window of the vehicle; a proximity sensor disposed inside the vehicle within a pre-defined distance of the print on the surface of the quarter window, wherein the proximity sensor is configured to: generate a first signal in response to detection of the print within a sensor detection range; and generate a second signal responsive to a lack of detection of the print with the sensor detection range; and a controller communicatively coupled to the proximity sensor and configured to issue a quarter window breakage notification for transmission to a vehicle alarm system of the vehicle in response to receiving the second signal from the proximity sensor.

In at least one embodiment, the proximity sensor is an inductive proximity sensor, and the print is a layer of a conductive metallic material.

In at least one embodiment, the proximity sensor is an inductive proximity sensor, and the print is a layer of a conductive silver material.

In at least one embodiment, the proximity sensor is a reed switch, and the print is a layer of a magnetic material.

In at least one embodiment, the surface of the quarter window is an inner surface of the quarter window.

In at least one embodiment, the surface of the quarter window is an outer surface of the quarter window.

In at least one embodiment, the proximity sensor is coupled to a window trim of the quarter window.

In at least one embodiment, a trim attachment bracket is coupled to a window trim of the quarter window and the proximity sensor is removably coupled to the trim attachment bracket.

In at least one embodiment, the system further includes a power and signal harness system electrically coupled to the proximity sensor, a power supply, and the controller, wherein the power and signal harness system is configured to supply power from the power supply to the proximity sensor and transmit the second signal from the proximity sensor to the controller.

In at least one embodiment, the proximity sensor is disposed within a distance ranging from 3 mm to 5 mm from the print on the quarter window.

In at least one embodiment, during an assembly process of the vehicle: the print is applied to on an inner surface of the quarter window prior to installation of the quarter window in the vehicle; prior to installation of a window trim on the vehicle, the proximity sensor is electrically coupled to a power and signal harness system and coupled to a trim attachment bracket, the trim attachment bracket being coupled to the window trim; the window trim is installed in the vehicle; and the quarter window including the print is installed in the vehicle following installation of the window trim.

In at least one embodiment, the controller is configured to issue the quarter window breakage signal for transmission to a vehicle monitoring center in response to receiving the second signal from the proximity sensor.

A vehicle including a system for detecting quarter window breakage in a vehicle includes: a print disposed on a surface of a quarter window; a proximity sensor disposed inside the vehicle within a pre-defined distance of the print on the surface of the quarter window, wherein the proximity sensor is configured to: generate a first signal in response to detection of the print within a sensor detection range; and generate a second signal responsive to a lack of detection of the print with the sensor detection range; and a controller communicatively coupled to the proximity sensor and configured to issue a quarter window breakage notification in response to receiving the second signal from the proximity sensor.

In at least one embodiment, the proximity sensor is an inductive proximity sensor, and the print is a layer of a conductive metallic material.

In at least one embodiment, the proximity sensor is an inductive proximity sensor, and the print is a layer of a conductive silver material.

In at least one embodiment, the proximity sensor is a reed switch, and the print is a layer of a magnetic material.

In at least one embodiment, the print is disposed on one of an inner surface of the quarter window and an outer surface of the quarter window.

In at least one embodiment, a trim attachment is coupled to a window trim of the quarter window and the proximity sensor is removably coupled to the trim attachment.

In at least one embodiment, the system includes a power and signal harness system electrically coupled to the proximity sensor, a power supply, and the controller, wherein the power and signal harness system is configured to supply power from the power supply to the proximity sensor and transmit the second signal from the proximity sensor to the controller.

A method for detecting window breakage in a vehicle includes: receiving, at a controller, a signal from a proximity sensor, wherein the proximity sensor is disposed inside the vehicle within a pre-defined distance of a print on a surface of a tempered glass window and is configured to generate the signal responsive to a lack of detection of the print within a sensor detection range; and transmitting a trigger to a vehicle alarm system in response to receiving the signal from the proximity sensor.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle including a quarter window breakage detection system in accordance with at least one embodiment;

FIG. 2 is a system including a quarter window breakage detection system in accordance with at least one embodiment;

FIG. 3 is a diagrammatic representation of a cross-sectional view of a proximity sensor and a print in a vehicle in accordance with at least one embodiment;

FIG. 4 is a flowchart representation of an exemplary method of detecting quarter window breakage in a vehicle in accordance with at least one embodiment; and

FIG. 5 is a flowchart representation of an exemplary method of installing the quarter window breakage detection system in a vehicle during a vehicle assembly process.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

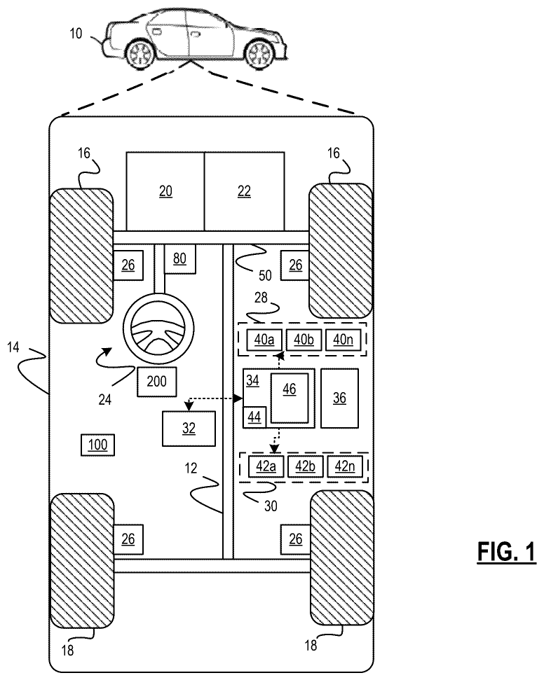

Referring to FIG. 1 is a functional block diagram of a vehicle 10 including a quarter window breakage detection system 100 in accordance with at least one embodiment. The vehicle 10 generally includes a chassis 12, a body 14, front wheels 16, and rear wheels 18. While the vehicle 10 is depicted in the illustrated embodiment as a passenger car, the vehicle 10 may be other types of vehicles including trucks, sport utility vehicles (SUVs), and recreational vehicles (RVs).

In various embodiments, the body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14.

In various embodiments, the vehicle 10 is an autonomous or semi-autonomous vehicle that is automatically controlled to carry passengers and/or cargo from one place to another. For example, in an exemplary embodiment, the vehicle 10 is a so-called Level Two, Level Three, Level Four or Level Five automation system. Level two automation means the vehicle assists the driver in various driving tasks with driver supervision. Level three automation means the vehicle can take over all driving functions under certain circumstances. All major functions are automated, including braking, steering, and acceleration. At this level, the driver can fully disengage until the vehicle tells the driver otherwise. A Level Four system indicates “high automation,” referring to the driving mode-specific performance by an automated driving system of all aspects of the dynamic driving task, even if a human driver does not respond appropriately to a request to intervene. A Level Five system indicates “full automation,” referring to the full-time performance by an automated driving system of all aspects of the dynamic driving task under all roadway and environmental conditions that can be managed by a human driver.

As shown, the vehicle 10 generally includes a propulsion system 20 a transmission system 22, a steering system 24, a braking system 26, a sensor system 28, an actuator system 30, at least one data storage device 32, at least one controller 34, and a communication system 36. The controller 34 is configured to implement an automated driving system (ADS). The propulsion system 20 is configured to generate power to propel the vehicle. The propulsion system 20 may, in various embodiments, include an internal combustion engine, an electric machine such as a traction motor, a fuel cell propulsion system, and/or any other type of propulsion configuration. The transmission system 22 is configured to transmit power from the propulsion system 20 to the vehicle wheels 16, 18 according to selectable speed ratios. According to various embodiments, the transmission system 22 may include a step-ratio automatic transmission, a continuously-variable transmission, or other appropriate transmission. The braking system 26 is configured to provide braking torque to the vehicle wheels 16, 18. The braking system 26 may, in various embodiments, include friction brakes, brake by wire, a regenerative braking system such as an electric machine, and/or other appropriate braking systems.

The steering system 24 is configured to influence a position of the of the vehicle wheels 16. While depicted as including a steering wheel and steering column, for illustrative purposes, in some embodiments contemplated within the scope of the present disclosure, the steering system 24 may not include a steering wheel and/or steering column. The steering system 24 includes a steering column coupled to an axle 50 associated with the front wheels 16 through, for example, a rack and pinion or other mechanism (not shown). Alternatively, the steering system 24 may include a steer by wire system that includes actuators associated with each of the front wheels 16.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, a steering wheel sensor, and/or other sensors.

The vehicle dynamics sensors provide vehicle dynamics data including longitudinal speed, yaw rate, lateral acceleration, longitudinal acceleration, etc. The vehicle dynamics sensors may include wheel sensors that measure information pertaining to one or more wheels of the vehicle 10. In one embodiment, the wheel sensors comprise wheel speed sensors that are coupled to each of the wheels 16, 18 of the vehicle 10. Further, the vehicle dynamics sensors may include one or more accelerometers (provided as part of an Inertial Measurement Unit (IMU)) that measure information pertaining to an acceleration of the vehicle 10. In various embodiments, the accelerometers measure one or more acceleration values for the vehicle 10, including latitudinal and longitudinal acceleration and yaw rate. In at least one embodiment, the vehicle dynamic sensors provide vehicle movement data.

The actuator system 30 includes one or more actuator devices 42a-42n that control one or more vehicle features such as, but not limited to, one or more vehicle wheels 16-18 the propulsion system 20, the transmission system 22, the steering system 24, and the braking system 26. In various embodiments, the vehicle features can further include interior and/or exterior vehicle features such as, but are not limited to, doors, a trunk, and cabin features such as air, music, lighting, etc. (not numbered).

The communication system 36 is configured to wirelessly communicate information to and from other entities 48, such as but not limited to, other vehicles (“V2V” communication,) infrastructure (“V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in the ADS of the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10. In various embodiments, the controller(s) 34 are configured to implement ADS.

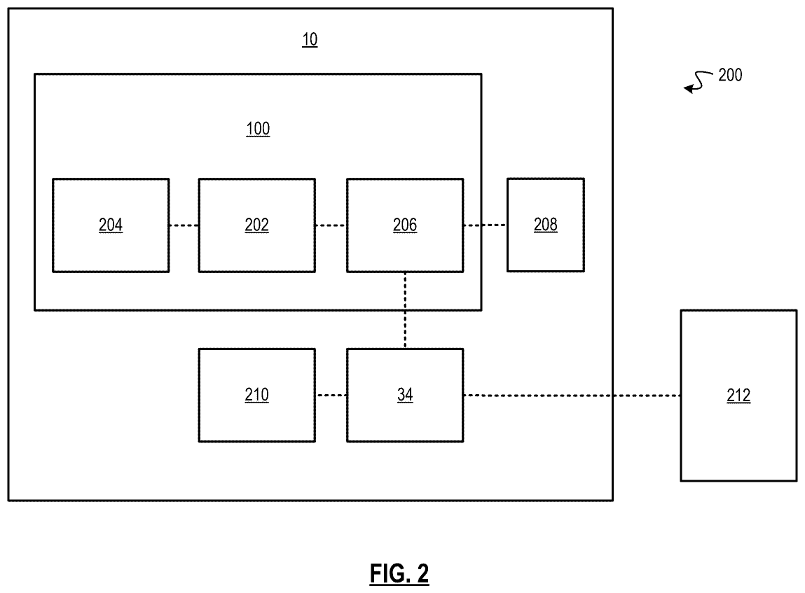

Referring to FIG. 2, a system 200 including a quarter window breakage detection system 100 in accordance with at least one embodiment is shown. The quarter window breakage detection system 100 includes a proximity sensor 202, a print 204, and a power and signal harness system 206.

The proximity sensor 202 is coupled to a window trim of a quarter window inside a vehicle 10. In at least one embodiment, a trim attachment bracket is coupled to the window trim of the quarter window. The proximity sensor 202 is coupled to the trim attachment bracket. In at least one embodiment, the proximity sensor 202 is removably coupled to the trim attachment bracket.

The print 204 is disposed on a surface of the quarter window. In at least one embodiment, the print 204 is disposed on an inner surface of the quarter window. In at least one embodiment, the print 204 is disposed on an outer surface of the quarter window.

The proximity sensor 202 is held in place by the trim attachment bracket with respect to the print 204. The proximity sensor 202 has an active detection surface. The print 204 is disposed on a portion of the quarter window that is generally aligned with the active detection surface of the proximity sensor 202 and within a sensor detection range of the proximity sensor 202. The active surface of the proximity sensor 202 is disposed within a pre-defined distance of the print 204. In at least one embodiment the active surface of the proximity sensor 202 is disposed at a distance ranging from three millimeters and five millimeters from the print 204 on the quarter window.

The proximity sensor 202 is configured to generate a window intact signal when the proximity sensor 202 detects the presence of the print 204 on the quarter window. The quarter window is typically made of a tempered glass. When the quarter window is broken, the tempered glass shatters and breaks into small pieces. The print 204 on the surface of the shattered glass no longer remains within the sensor detection range of the proximity sensor 202. The proximity sensor 202 is configured to generate a window breakage signal in response to a lack of detection of the print 204 within the sensor detection range of the proximity sensor 202.

In at least one embodiment, the window intact signal is a voltage having a first voltage value and the window breakage signal is a voltage having a second voltage value. The first voltage value is different from the second voltage value. In at least one embodiment, the first voltage value is greater than the second voltage value. In at least one embodiment, the first voltage value is less than the second voltage value.

In at least one embodiment, the proximity sensor 202 is an inductive proximity sensor and the print 204 is a layer of a conductive metallic material. In at least one embodiment, the layer of the conductive metallic material is a layer of a conductive silver material. In at least one embodiment, the inductive proximity sensor includes a sensor coil, an oscillator, and a Schmitt trigger circuit.

The sensor coil generates an alternating current (AC) based magnetic field. When the quarter window is intact, the print 204 (made of the layer of the conductive metallic material) remains within the sensor detection range defined by the magnetic field and eddy currents circulate around the print 204. The eddy currents cause an impedance of the magnetic field. The impedance causes a sensor oscillation generated by the oscillator to have an amplitude. The amplitude is below a threshold amplitude causing the Schmitt trigger circuit to turn on the proximity sensor. The proximity sensor generates a proximity sensor output. The proximity sensor output is a window intact signal. In at least one embodiment, the window intact signal has a first voltage value.

When the quarter window is broken, the tempered glass shatters and breaks into small pieces. The print 204 on the surface of the shattered glass no longer remains within the sensor detection range of the inductive proximity sensor. The inductive proximity sensor is no longer able to detect the presence of the print 204. The inductive proximity sensor turns off and the proximity sensor output has a second voltage value of zero. The window breakage signal has the second voltage value.

In at least one embodiment, the proximity sensor 202 is a reed switch and the print 204 is a layer of a magnetic material. In at least one embodiment, the reed switch includes two ferromagnetic blades that are separated by a few microns. When the quarter window is intact, the print 204 (made of the layer of the magnetic material) remains within a sensor detection range of the reed switch. The magnetic material of the print 204 causes the two ferromagnetic blades to pull toward one another causing contact between the two ferromagnetic blades enabling electricity to flow and generate a first proximity sensor output. The first proximity sensor output is a window intact signal.

When the quarter window is broken, the tempered glass shatters and breaks into small pieces. The print 204 on the surface of the shattered glass no longer remains within the sensor detection range of the reed switch. The two ferromagnetic blades separate disabling the flow of electricity and generate second a proximity sensor output. The second proximity sensor output is a window breakage signal.

In at least one embodiment, the reed switch includes two non-ferromagnetic blades that are separated by a few microns. When the quarter window is intact, the print 204 (made of the layer of the magnetic material) remains within a sensor detection range of the reed switch. The magnetic material of the print 204 causes the two non-ferromagnetic blades to pull away from each other to disable a flow of electricity and to generate a first proximity sensor output. The first proximity sensor output is a window intact signal.

When the quarter window is broken, the tempered glass shatters and breaks into small pieces. The print 204 on the surface of the shattered glass no longer remains within the sensor detection range of the reed switch and causes the two non-ferromagnetic blades to pull toward one another causing contact between the two non-ferromagnetic blades allowing electricity to flow and generate a second proximity sensor output. The second proximity sensor output is a window breakage signal.

The power and signal harness system 206 is communicatively coupled to the proximity sensor 202 and a controller 34. The controller 34 is similar to the controller 34 described with reference to FIG. 1. The power and signal harness system 206 is configured to transmit the proximity sensor output signals generated by the proximity sensor 202 to the controller 34. When the proximity sensor 202 generates the window intact signal, the controller 34 is configured to receive the window intact signal from the proximity sensor 202 via the power and signal harness system 206. When the proximity sensor 202 generates the window breakage signal, the controller 34 is configured to receive the window breakage signal from the proximity sensor 202 via the power and signal harness system 206. In at least one embodiment, the power and signal harness system 206 receives the proximity sensor output from the proximity sensor 202 as an input and generates an adjusted proximity sensor output in the form of a controller input signal.

In at least one embodiment, the power supply 208 is a battery system of the vehicle 10. The power and signal harness system 206 is electrically coupled to the proximity sensor 202 and to the power supply 208. The power and signal harness system 206 is configured to supply power from the power supply 208 to the proximity sensor 202.

The controller 34 is configured to be communicatively coupled to a vehicle alarm system 210. The controller 34 is configured to transmit a quarter window breakage notification to the vehicle alarm system 210 in response to receiving the window breakage signal from the proximity sensor 202. The vehicle alarm system 210 is configured to generate an alarm in response to receipt of the quarter window breakage notification. In at least one embodiment, the generated alarm is an audio alarm generated by a siren of the vehicle 10.

In at least one embodiment, the controller 34 is configured to establish a communication channel with a vehicle monitoring center 212 in response to receiving the window breakage signal from the proximity sensor 202. The controller 34 is configured to transmit the quarter window breakage notification to the vehicle monitoring center 212. In at least one embodiment, the controller 34 is configured to include a location of the vehicle and a vehicle identifier with the quarter window breakage notification transmitted to the vehicle monitoring center 212. In at least one embodiment, the vehicle monitoring center 212 contacts a police station to dispatch police to a location of the vehicle 10.

In at least one embodiment, the controller 34 is placed in a default sleep mode and remains in the default sleep mode when the controller 34 receives the window intact signal. The controller 34 wakes up in response to receipt of the window breakage signal. The quarter window breakage detection system 100 may include additional components that facilitate operation of the quarter window breakage detection system 100.

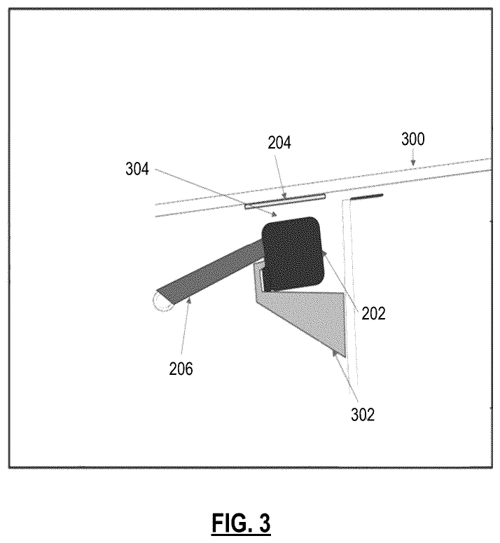

Referring to FIG. 3, a diagrammatic representation of a cross-sectional view of a proximity sensor 202 and a print 204 in a vehicle 10 in accordance with at least one embodiment is shown. The print 204 is disposed on an inner surface of a quarter window 300 of a vehicle 10. A trim attachment bracket 302 is coupled to a window trim of the quarter window 300. The proximity sensor 202 is removably coupled to the trim attachment bracket 302. The trim attachment bracket 302 positions the proximity sensor 202 within a pre-defined distance 304 of the print 204. The pre-defined distance 304 is based on a sensor detection range of the proximity sensor 202. The proximity sensor 202 is electrically coupled to a power and signal harness system 206.

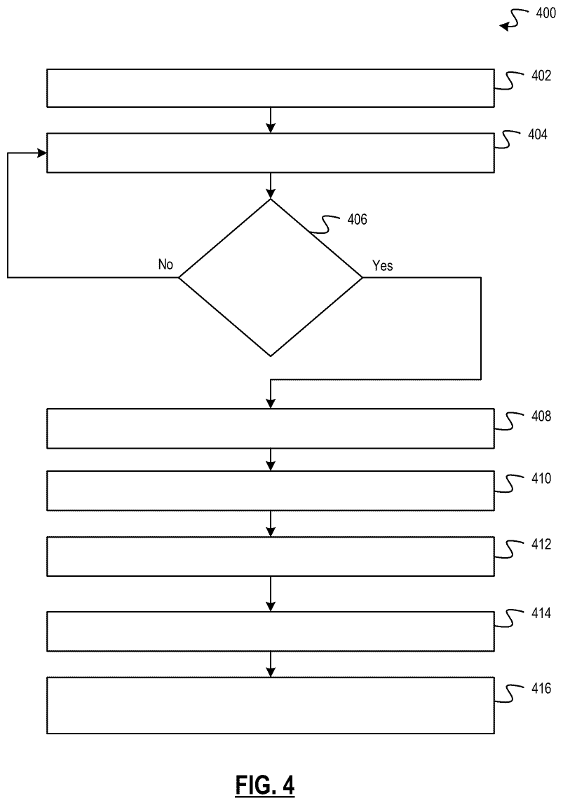

Referring to FIG. 4, a flowchart representation of an exemplary method 400 of detecting quarter window breakage in a vehicle 10 in accordance with at least one embodiment is shown. As can be appreciated in light of the disclosure, the order of operation within the method 400 is not limited to the sequential execution as illustrated in FIG. 4 but may be performed in one or more varying orders as applicable and in accordance with the present disclosure.

At 402, a controller 34 enters a default sleep mode. At 404, a proximity sensor output signal is received from a proximity sensor 202 associated with a quarter window 300 of a vehicle 10 at the controller 34. The proximity sensor output signal is one of a window intact signal and a window breakage signal. A window intact signal indicates that the quarter window 300 is intact. A window breakage signal indicates that the quarter window 300 has been broken.

At 406, the controller 34 determines whether the proximity sensor output signal is a window breakage signal. If the controller 34 determines that the proximity sensor output signal is not a window breakage signal, the method 400 returns to 404. If the controller 34 determines that the proximity sensor output signal is a window breakage signal, the controller 34 transitions from the sleep mode to a wake-up mode at 408.

At 410, the controller 34 generates a quarter window breakage notification in response to receipt of the window breakage signal. At 412, the controller 34 transmits the quarter window breakage notification to a vehicle alarm system 210 of the vehicle. The vehicle alarm system 210 generates an alarm in response to receipt of the quarter window breakage notification.

At 414, the controller 34 establishes a communication channel between the vehicle 10 and a vehicle monitoring center 212. At 416, the controller 34 transmits the quarter window breakage notification, a location of the vehicle 10, and a vehicle identifier of the vehicle 10 to the vehicle monitoring center 212. The vehicle monitoring center 212 contacts a police station to dispatch police to a location of the vehicle 10. While the method 400 describes a quarter window, in alternative embodiments, the window may be any vehicle window that is made of tempered glass.

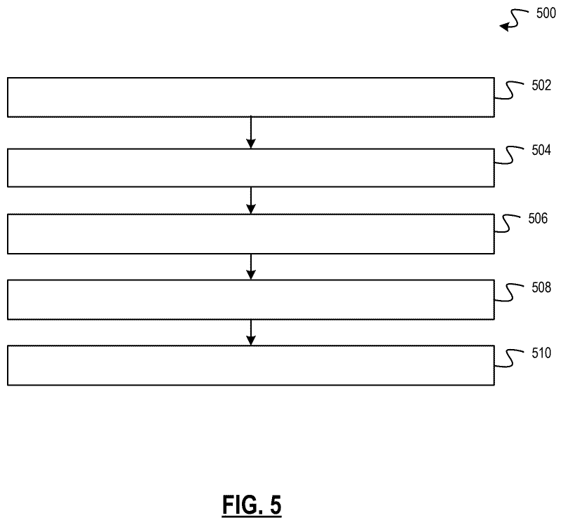

FIG. 5 is a flowchart representation of an exemplary method 500 of installing the quarter window breakage detection system 100 in a vehicle 10 during a vehicle assembly process. As can be appreciated in light of the disclosure, the order of operation within the method 500 is not limited to the sequential execution as illustrated in FIG. 5 but may be performed in one or more varying orders as applicable and in accordance with the present disclosure.

At 502, a print 204 is applied to an inner surface of the quarter window 300. In at least one embodiment, the print is applied to the inner surface of the quarter window 300 at a glass supplier of the quarter window 300 prior to shipping of the quarter window 300 to a vehicle assembly plant. At 504, a proximity sensor 202 associated with a quarter window 300 of the vehicle 10 is electrically coupled to a power and signal harness system 206 of the vehicle 10. At 506, the proximity sensor 202 is coupled to a trim attachment bracket 302. The trim attachment bracket 302 is coupled to a window trim of the quarter window 300. At 508, the window trim is installed in the vehicle 10. At 510, the quarter window 300 is installed in the vehicle 10. While the method 500 describes a quarter window, in alternative embodiments, the window may be any vehicle window that is made of tempered glass.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for detecting quarter window breakage in a vehicle, comprising:
a print disposed on a surface of a quarter window of the vehicle;
a proximity sensor disposed inside the vehicle within a pre-defined distance of the print on the surface of the quarter window, wherein the proximity sensor is configured to:
generate a first signal in response to detection of the print within a sensor detection range; and
generate a second signal responsive to a lack of detection of the print with the sensor detection range; and
a controller communicatively coupled to the proximity sensor and configured to issue a quarter window breakage notification for transmission to a vehicle alarm system of the vehicle in response to receiving the second signal from the proximity sensor.

2. The system of claim 1, wherein the proximity sensor is an inductive proximity sensor, and the print is a layer of a conductive metallic material.

3. The system of claim 1, wherein the proximity sensor is an inductive proximity sensor, and the print is a layer of a conductive silver material.

4. The system of claim 1, wherein the proximity sensor is a reed switch, and the print is a layer of a magnetic material.

5. The system of claim 1, wherein the surface of the quarter window is an inner surface of the quarter window.

6. The system of claim 1, wherein the surface of the quarter window is an outer surface of the quarter window.

7. The system of claim 1, wherein the proximity sensor is coupled to a window trim of the quarter window.

8. The system of claim 1, wherein a trim attachment bracket is coupled to a window trim of the quarter window and the proximity sensor is removably coupled to the trim attachment bracket.

9. The system of claim 1, further comprising a power and signal harness system electrically coupled to the proximity sensor, a power supply, and the controller, wherein the power and signal harness system is configured to supply power from the power supply to the proximity sensor and transmit the second signal from the proximity sensor to the controller.

10. The system of claim 1, wherein the proximity sensor is disposed within a distance ranging from 3 mm to 5 mm from the print on the quarter window.

11. The system of claim 1, wherein during an assembly process of the vehicle:
the print is applied to on an inner surface of the quarter window prior to installation of the quarter window in the vehicle;
prior to installation of a window trim on the vehicle, the proximity sensor is electrically coupled to a power and signal harness system and coupled to a trim attachment bracket, the trim attachment bracket being coupled to the window trim;
the window trim is installed in the vehicle; and
the quarter window including the print is installed in the vehicle following installation of the window trim.

12. The system of claim 1, wherein the controller is configured to issue the quarter window breakage signal for transmission to a vehicle monitoring center in response to receiving the second signal from the proximity sensor.

13. A vehicle including a system for detecting quarter window breakage in a vehicle, comprising:
a print disposed on a surface of a quarter window;
a proximity sensor disposed inside the vehicle within a pre-defined distance of the print on the surface of the quarter window, wherein the proximity sensor is configured to:
generate a first signal in response to detection of the print within a sensor detection range; and
generate a second signal responsive to a lack of detection of the print with the sensor detection range; and
a controller communicatively coupled to the proximity sensor and configured to issue a quarter window breakage notification in response to receiving the second signal from the proximity sensor.

14. The vehicle of claim 13, wherein the proximity sensor is an inductive proximity sensor, and the print is a layer of a conductive metallic material.

15. The vehicle of claim 13, wherein the proximity sensor is an inductive proximity sensor, and the print is a layer of a conductive silver material.

16. The vehicle of claim 13, wherein the proximity sensor is a reed switch, and the print is a layer of a magnetic material.

17. The vehicle of claim 13, wherein the print is disposed on one of an inner surface of the quarter window and an outer surface of the quarter window.

18. The vehicle of claim 13, wherein a trim attachment is coupled to a window trim of the quarter window and the proximity sensor is removably coupled to the trim attachment.

19. The vehicle of claim 13, further comprising a power and signal harness system electrically coupled to the proximity sensor, a power supply, and the controller, wherein the power and signal harness system is configured to supply power from the power supply to the proximity sensor and transmit the second signal from the proximity sensor to the controller.

20. A method for detecting window breakage in a vehicle comprising:
receiving, at a controller, a signal from a proximity sensor, wherein the proximity sensor is disposed inside the vehicle within a pre-defined distance of a print on a surface of a tempered glass window and is configured to generate the signal responsive to a lack of detection of the print within a sensor detection range; and
transmitting a trigger to a vehicle alarm system in response to receiving the signal from the proximity sensor.
